(19) United States
(12) Patent Application Publication
(10) Pub. No.: US 2026/0166455 A1
(43) Pub. Date: Jun. 18, 2026

(54) Backwash Orifice Arrangement

(71) Applicant: Xylem Water Solution U.S.A., Inc., Brown Deer, WI (US)

(72) Inventors: Wenjun Liu, Mars, PA (US); Benay Akyon, Pittsburgh, PA (US)

(21) Appl. No.: 19/129,358

(22) PCT Filed: Nov. 14, 2023
(86) PCT No.: PCT/US2023/079620

§ 371 Date: May 13, 2025

(51) Int. Cl. B01D 33/50; B01D 33/21

(52) U.S. Cl. CPC B01D 33/50; B01D 33/21

(57) ABSTRACT

A solid-liquid separation system includes: a rotating filter configured to separate a solid-liquid containing stream into a filtrate component and a solids component, where the rotating filter has a rotation point around which the rotating filter rotates; and a plurality of backwash orifices including a first backwash orifice arranged to emit backwash water at a first region of the filter and a second backwash orifice arranged to emit the backwash water at a second region of the filter different from the first region, where the first region is closer to the rotation point than the second region, where the second backwash orifice emits the backwash water at the second region and the first backwash orifice emits the backwash water at the first region such that the second region experiences a higher flow rate than the first region.

### CROSS-REFERENCE TO RELATED APPLICATION

This application claims priority to U.S. Provisional Application No. 63/425,173, filed Nov. 14, 2022, the disclosure of which is hereby incorporated by reference in its entirety.

### BACKGROUND

### Field

The present disclosure relates to solid-liquid separation, and particularly to systems and methods for cleaning filters in a solid-liquid separation system.

### Description of Related Art

Solid-liquid separation, such as wastewater treatment, is considered an energy intensive process. For example, during the wastewater treatment process, sludge commonly forms a layer on the surface of a filter used to separate the sludge from the filtered water. Part of the energy required to effect the wastewater treatment is expended to remove the sludge layer from the surface of the filter, in order to allow the filter to effectively continue to separate the solid and liquid components. The sludge layer can be removed using orifices that emit backwash water to contact the sludge layer, which removes the sludge layer from the surface of the filter. Emitting the backwash water at an insufficient backwash intensity (liters/min/m²) results in the filter being insufficiently cleaned. However, emitting the backwash water at an excessive backwash intensity and/or using excessive pumping pressures requires higher energy expenditures. This problem is complicated for filters of certain geometries and arrangements (e.g., rotating disc filters) in which different regions of the filter create a non-uniform coverage area to be cleaned.

### SUMMARY

In view of the foregoing, systems and methods for cleaning filter in a solid-liquid separation system that reduce the energy and cost consumptions while sufficiently cleaning the filter is desired.

In some non-limiting embodiments or aspects, a solid-liquid separation system includes: a rotating filter configured to separate a solid-liquid containing stream into a filtrate component and a solids component, where the rotating filter has a rotation point around which the rotating filter rotates and a perimeter defining an end of the filter; and a plurality of backwash orifices including a first backwash orifice arranged to emit backwash water at a first region of the filter and a second backwash orifice arranged to emit the backwash water at a second region of the filter different from the first region, where the first region is closer to the rotation point than the second region, where the second backwash orifice emits the backwash water at the second region and the first backwash orifice emits the backwash water at the first region such that the second region experiences a higher flow rate than the first region.

The first region and the second region may partially overlap such that the first backwash orifice emits the backwash water at an overlapping portion of the first and second region and/or the second backwash orifice emits the backwash water at the overlapping portion of the first and second region. The rotating filter may include a first side incident with the solid-liquid containing stream and a second side from which the filtrate component emerges, where the plurality of backwash orifices emit the backwash water at the second side. The second backwash orifice may emit the backwash water at a higher flow rate than the first backwash orifice. A linear velocity of the rotating filter in the first region may be slower than a linear velocity of the rotating filter in the second region. The rotating filter may include a layer of the solids component formed on a surface, where the first backwash orifice and the second backwash orifice are arranged to emit the backwash water at the layer of the solids component so as to remove at least a portion of the layer of the solids component from the surface. A slope of a line denoting backwash intensity as a function of a distance from the rotation point of the rotating filter may be greater than or equal to −2 liter/min/m³, such as greater than or equal to −1 liter/min/m³, greater than or equal to 0 liter/min/m³, or greater than or equal to 1 liter/min/m³. A slope of a line denoting backwash intensity as a function of a distance from the rotation point of the rotating filter may be greater than or equal to 2 liter/min/m³. The rotating filter may be a rotating disc. The rotating filter may be substantially vertical. The plurality of backwash orifices may be directly perforated on a backwash pipe. Each of the plurality of backwash orifices may include a backwash nozzle, where each backwash nozzle may be configured to emit the backwash water at a different flow rate. The solid-liquid separation system may be a wastewater treatment system in which the solid-liquid containing stream is a wastewater stream or a mixed liquor stream of secondary biological treatment systems, the solids component is a sludge component, and the filtrate component is filtered water.

In some non-limiting embodiments or aspects, a solid-liquid treatment unit includes: a plurality of solid-liquid separation systems described herein; and a pump system in fluid communication with the plurality of solid-liquid separation systems, where the pump system is configured to pump backwash water to each of the plurality of solid-liquid separation systems.

A flowrate of the backwash water to a first solid-liquid separation system of the plurality of solid-liquid separation systems may be within 25% deviation relative to a flowrate of the backwash water to a second solid-liquid separation system of the plurality of solid-liquid separation systems. The solid-liquid separation systems may be wastewater treatment systems in which the solid-liquid containing streams are wastewater streams or mixed liquor stream of secondary biological treatment systems, the solids components are sludge components, and the filtrate components are filtered water.

In some non-limiting embodiments or aspects, a method for cleaning a solid-liquid separation system includes: arranging a plurality of backwash orifices to emit backwash water at a rotating filter configured to separate a solid-liquid containing stream into a filtrate component and a solids component, where the rotating filter includes a layer of the solids component formed on a surface, where the rotating filter has a rotation point around which the rotating filter rotates and a perimeter defining an end of the filter; and emitting the backwash water from the plurality of backwash orifices at the filter so as to remove at least a portion of the layer of the solids component from the surface, where the plurality of backwash orifices include a first backwash orifice arranged to emit backwash water at a first region of the filter and a second backwash orifice arranged to emit the backwash water at a second region of the filter different from the first region, where the first region is closer to the rotation point than the second region, where the second backwash orifice emits the backwash water at the second region and the first backwash orifice emits the backwash water at the first region such that the second region experiences a higher flow rate than the first region.

The solid-liquid separation system may be a wastewater treatment system in which the solid-liquid containing stream is a wastewater stream or mixed liquor stream of secondary biological treatment systems, the solids component is a sludge component, and the filtrate component is filtered water. The method may further include: collecting the at least a portion of the layer of the sludge component removed from the surface; and removing the collected at least a portion of the layer of the sludge component from a tank in which the wastewater treatment system is arranged. The method may further include: arranging the rotating filter in a tank; filling the tank with wastewater; rotating the filter to separate the filtrate component from the wastewater, where the filtrate component includes filtered water; and removing the filtered water from the tank.

The first region and the second region may partially overlap such that the first backwash orifice emits the backwash water at an overlapping portion of the first and second region and/or the second backwash orifice emits the backwash water at the overlapping portion of the first and second region. A slope of a line denoting backwash intensity as a function of a distance from the rotation point of the rotating filter may be greater than or equal to −2 liter/min/m³, such as greater than or equal to −1 liter/min/m³, greater than or equal to 0 liter/min/m³, greater than or equal to 1 liter/min/m³, or greater than or equal to 2 liter/min/m³.

Various non-limiting embodiments or aspects of the present disclosure will now be described and set forth in the following numbered clauses:

Clause 1: A solid-liquid separation system, comprising: a rotating filter configured to separate a solid-liquid containing stream into a filtrate component and a solids component, wherein the rotating filter has a rotation point around which the rotating filter rotates and a perimeter defining an end of the filter; and a plurality of backwash orifices comprising a first backwash orifice arranged to emit backwash water at a first region of the filter and a second backwash orifice arranged to emit the backwash water at a second region of the filter different from the first region, wherein the first region is closer to the rotation point than the second region, wherein the second backwash orifice emits the backwash water at the second region and the first backwash orifice emits the backwash water at the first region such that the second region experiences a higher flow rate than the first region.

Clause 2: The solid-liquid separation system of clause 1, wherein the first region and the second region partially overlap such that the first backwash orifice emits the backwash water at an overlapping portion of the first and second region and/or the second backwash orifice emits the backwash water at the overlapping portion of the first and second region.

Clause 3: The solid-liquid separation system of clause 1 or 2, wherein the rotating filter comprises a first side incident with the solid-liquid containing stream and a second side from which the filtrate component emerges, wherein the plurality of backwash orifices emit the backwash water at the second side.

Clause 4: The solid-liquid separation system of any of clauses 1-3, wherein the second backwash orifice emits the backwash water at a higher flow rate than the first backwash orifice.

Clause 5: The solid-liquid separation system of any of clauses 1-4, wherein a linear velocity of the rotating filter in the first region is lower than a linear velocity of the rotating filter in the second region.

Clause 6: The solid-liquid separation system of any of clauses 1-5, wherein the rotating filter comprises a layer of the solids component formed on a surface, wherein the first backwash orifice and the second backwash orifice are arranged to emit the backwash water at the layer of the solids component so as to remove at least a portion of the layer of the solids component from the surface.

Clause 7: The solid-liquid separation system of any of clauses 1-6, wherein a slope of a line denoting backwash intensity as a function of a distance from the rotation point of the rotating filter is greater than or equal to −2 liter/min/m³, such as greater than or equal to −1 liter/min/m³, greater than or equal to −0.5 liter/min/m³, greater than or equal to 0 liter/min/m³, or greater than or equal to 1 liter/min/m³.

Clause 8: The solid-liquid separation system of any of clauses 1-7, wherein a slope of a line denoting backwash intensity as a function of a distance from the rotation point of the rotating filter is greater than or equal to 2 liter/min/m³.

Clause 9: The solid-liquid separation system of any of clauses 1-8, wherein the rotating filter is a rotating disc.

Clause 10: The solid-liquid separation system of any of clauses 1-9, wherein the rotating filter is substantially vertical.

Clause 11: The solid-liquid separation system of any of clauses 1-10, where the plurality of backwash orifices are directly perforated on a backwash pipe.

Clause 12: The solid-liquid separation system of any of clauses 1-11, wherein each of the plurality of backwash orifices comprises a backwash nozzle, wherein each backwash nozzle is configured to emit the backwash water at a different flow rate.

Clause 13: The solid-liquid separation system of any of clauses 1-12, wherein the solid-liquid separation system is a wastewater treatment system in which the solid-liquid containing stream is a wastewater stream or a mixed liquor stream of secondary biological treatment systems, the solids component is a sludge component, and the filtrate component is filtered water.

Clause 14: A solid-liquid treatment unit, comprising: a plurality of solid-liquid separation systems of any of clauses 1-13; and a pump system in fluid communication with the plurality of solid-liquid separation systems, wherein the pump system is configured to pump backwash water to each of the plurality of solid-liquid separation systems.

Clause 15: The solid-liquid treatment unit of clause 14, wherein a flowrate of the backwash water to a first solid-liquid separation system of the plurality of solid-liquid separation systems is within 25% deviation relative to a flowrate of the backwash water to a second solid-liquid separation system of the plurality of solid-liquid separation systems.

Clause 16: The solid-liquid treatment unit of clause 14 or 15, wherein the solid-liquid separation systems are wastewater treatment systems in which the solid-liquid containing streams are wastewater streams or mixed liquor stream of secondary biological treatment systems, the solids components are sludge components, and the filtrate components are filtered water.

Clause 17: A method for cleaning a solid-liquid separation system, comprising: arranging a plurality of backwash orifices to emit backwash water at a rotating filter configured to separate a solid-liquid containing stream into a filtrate component and a solids component, wherein the rotating filter comprises a layer of the solids component formed on a surface, wherein the rotating filter has a rotation point around which the rotating filter rotates and a perimeter defining an end of the filter; and emitting the backwash water from the plurality of backwash orifices at the filter so as to remove at least a portion of the layer of the solids component from the surface, wherein the plurality of backwash orifices comprise a first backwash orifice arranged to emit backwash water at a first region of the filter and a second backwash orifice arranged to emit the backwash water at a second region of the filter different from the first region, wherein the first region is closer to the rotation point than the second region, wherein the second backwash orifice emits the backwash water at the second region and the first backwash orifice emits the backwash water at the first region such that the second region experiences a higher flow rate than the first region.

Clause 18: The method of clause 17, wherein the solid-liquid separation system is a wastewater treatment system in which the solid-liquid containing stream is a wastewater stream or mixed liquor stream of secondary biological treatment systems, the solids component is a sludge component, and the filtrate component is filtered water.

Clause 19: The method of clause 18, further comprising: collecting the at least a portion of the layer of the sludge component removed from the surface; and removing the collected at least a portion of the layer of the sludge component from a tank in which the wastewater treatment system is arranged.

Clause 20: The method of clause 18 or 19, further comprising: arranging the rotating filter in a tank; filling the tank with wastewater; rotating the filter to separate the filtrate component from the wastewater, wherein the filtrate component comprises filtered water; and removing the filtered water from the tank.

Clause 21: The method of any of clauses 17-20, wherein the first region and the second region partially overlap such that the first backwash orifice emits the backwash water at an overlapping portion of the first and second region and/or the second backwash orifice emits the backwash water at the overlapping portion of the first and second region.

Clause 22: The method of any of clauses 17-21, wherein a slope of a line denoting backwash intensity as a function of a distance from the rotation point of the rotating filter is greater than or equal to −2 liter/min/m³, such as greater than or equal to −1 liter/min/m³, greater than or equal to 0 liter/min/m³, greater than or equal to 1 liter/min/m³, or greater than or equal to 2 liter/min/m³.

### BRIEF DESCRIPTION OF THE DRAWINGS

FIG. 1 is a schematic diagram of a wastewater treatment system, according to some non-limiting embodiments or aspects;

FIG. 2 is a schematic diagram of a wastewater treatment system, according to some non-limiting embodiments or aspects;

FIG. 3 is a partial cross-sectional view of a filter device arranged in a wastewater tank, according to some non-limiting embodiments or aspects;

FIG. 4 is a schematic view of a filter device, according to some non-limiting embodiments or aspects;

FIG. 5 is a schematic view of a filter element, according to some non-limiting embodiments or aspects;

FIG. 6 is a cross-sectional view of a filter device in a wastewater treatment system, according to some non-limiting embodiments or aspects;

FIG. 7 is a cutaway view of a plurality of opposite facing liquid-permeable filter elements separated by a gap, according to some non-limiting embodiments or aspects;

FIG. 8 is a schematic view of a backwash pipe having orifices emitting backwash water to create at least one overlapping region of the filter element, according to some non-limiting embodiments or aspects;

FIG. 9 is schematic view of a circular filter device at which four orifices are directing backwash water, according to some non-limiting embodiments or aspects;

FIG. 10 is a schematic view of a solid-liquid treatment unit, according to some non-limiting embodiments or aspects; and

FIG. 11 is a graph of backwash flow intensity (liters/min/m²) as a function of a distance from the rotation point of the rotating filter from Example 17, according to some non-limiting embodiments or aspects.

### DETAILED DESCRIPTION

For purposes of the description hereinafter, the terms “upper,” “lower,” “right,” “left,” “vertical,” “horizontal,” “top,” “bottom,” “lateral,” “longitudinal,” and derivatives thereof shall relate to the invention as it is oriented in the drawing figures. However, it is to be understood that the invention may assume alternative variations and step sequences, except where expressly specified to the contrary. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as limiting.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances. Further, in this application, the use of “a” or “an” means “at least one” unless specifically stated otherwise.

The present disclosure is directed to a solid-liquid separation system, comprising: a rotating filter configured to separate a solid-liquid containing stream into a filtrate component and a solids component, wherein the rotating filter has a rotation point around which the rotating filter rotates and a perimeter defining an end of the filter; and a plurality of backwash orifices comprising a first backwash orifice arranged to emit backwash water at a first region of the filter and a second backwash orifice arranged to emit the backwash water at a second region of the filter different from the first region, wherein the first region is closer to the rotation point than the second region, wherein the second backwash orifice emits the backwash water at the second region and the first backwash orifice emits the backwash water at the first region such that the second region experiences a higher flow rate than the first region.

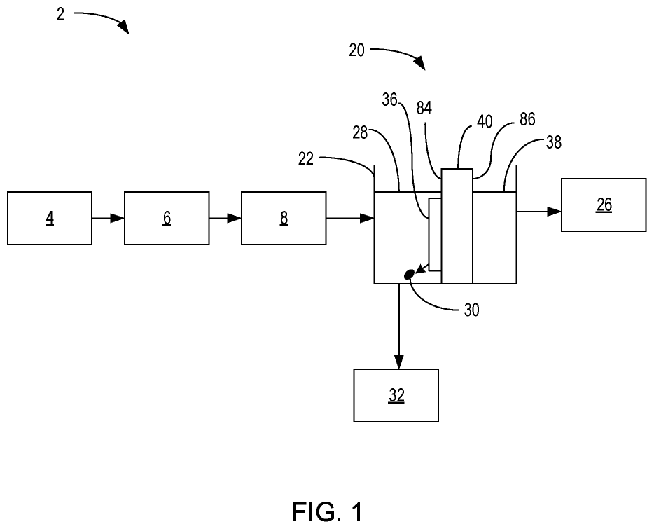

Referring to FIG. 1, a system 2 for processing a solid-liquid stream is shown. The solid-liquid stream will be discussed primarily in the context of a wastewater stream, but other types of solid-liquid streams are also within the scope of this disclosure. The wastewater stream may produce a slurry, which may be reused as fuel in a waste to energy process and a clean water filtrate including filtered water. Contaminated water 4 may be provided from a source of contaminated water to a treatment zone 6. Contaminated water 4 is commonly supplied to the treatment zone 6 from supply infrastructure in the ground for contaminated water, which is common in many water treatment systems. Said infrastructure and its corresponding piping network can be reused with minor upgrades to the pumping stations for the systems described herein. Other non-limiting examples of sources of contaminated water include municipal, industrial, and/or agricultural sources, such as, for example, municipal wastewater.

Once the contaminated water 4 enters the treatment zone 6, the contaminated water 4 may be subject to various processes. The treatment zone 6 may perform various physical, chemical, and/or biological treatment processes. For example, the contaminated water 4 may be subject to coarse screening to remove contaminants having a size of 20 mm or greater, followed by fine screening to remove contaminants having a size of 6 mm or greater. Further processes may include fat, oil, and/or grease removal. The grit, sand, and other contaminants removed from the contaminated water 4 in the treatment zone 6 may be disposed of by any conventional means, such as disposed of in a landfill. Treatment zone 6 may perform biological processes that may include aerobic COD (Chemical Oxygen Demand) removal, nitrification, denitrification, an anoxic zone, and combinations thereof. Treatment zone 6 may perform clarification processes. Treatment zone may include various recirculation processes, such as sludge recycle and/or mixed liquor recycle.

The liquid stream that exits the treatment zone 6 may be considered pre-treated sewage and/or wastewater 8 that is free of large debris and contaminants, but that still contains dissolved organics, inorganics, and suspended solids. This liquid stream that exits the treatment zone 6 will be referred to herein as wastewater 8. The wastewater 8 may contain various amounts of dissolved and/or suspended solids.

The wastewater 8 may be industrial or municipal, and may include material having a size of less than 20 mm. It may be advantageous for the present systems and processes to have a range of organic material contaminants in the wastewater 8 measured as COD, BOD, and TKN as well as having some amount of total suspended solids (TSS). A wide range of organic contamination in the water can be handled by the system and process according to the disclosure, including most complicated industrial wastewaters.

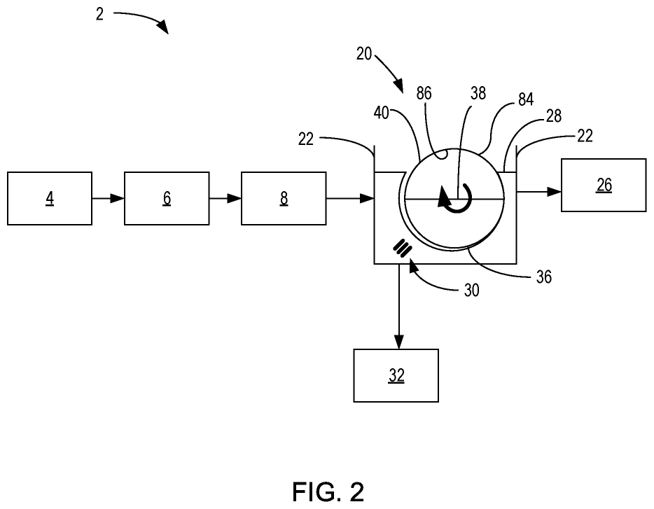

The system 2 may comprise a wastewater tank 22 in which may be performed (as non-limiting examples) biological processes that may include aerobic COD (Chemical Oxygen Demand) removal, nitrification, denitrification, an anoxic zone, and combinations thereof. The system 2 may comprise the filter device 20 comprising at least one liquid-permeable filter element 40, such as a plurality of liquid-permeable filter elements 40. The wastewater tank 22 may be any object configured to hold a volume of liquid. The at least one liquid-permeable filter element 40 may comprise a filtering mesh. The filtering mesh may comprise stainless steel, polyester, nylon, polytetrafluoroethylene (PTFE, such as Teflon), polyvinylidene fluoride (PVDF), and/or any other suitable material. The material of the filtering mesh may be a material chemically resistant to and/or inert to corrosion caused by wastewater 8. The filter device 20 may have any shape known in the art. For example, the filter device 20 may have a circular or rectangular cross-section, as shown in FIGS. 1-2. The filter device 20 may include a single stationary liquid-permeable filter element 40. The filter device 20 may include a plurality of liquid-permeable filter elements 40. The at least one liquid permeable filter element 40 comprises a first side 84 and a second side 86 opposite of the first side 84. In a solid-liquid separate system, the first side 84 (e.g., the dirty side) may be the side incident the solid-liquid containing stream (e.g., a wastewater stream or mixed liquor stream of secondary biological treatment), and the second side 86 (e.g., the clean side) may be the side from which filtrate (e.g., filtered water) emerges. The solids component (e.g., sludge component) of the solid-liquid containing stream may remain on the first side 84, blocked by the filter elements 40.

For example, the filter device 20 may be in the form of a disc or a drum. If the filter device 20 is a disc or a drum, the disc or drum may rotate to facilitate filtering by the liquid-permeable filter elements 40, as indicated by the curved arrow in FIG. 2. If the filter device 20 is a disc or a drum, the first side 84 of the disc or drum may be the external surface where the cake layer 36 of sludge component forms, while the second side 86 is the internal surface of the disc or drum and contained within the disc or drum. Referring to FIG. 2, during rotation of the disc or drum, the pressure from the wastewater 8 aids in filtration thereof, thereby producing a cake layer 36 on the first side 84 of the disc or drum. The filtrate 26 may be collected and transferred to external to the filter device 20 via a transportation apparatus, such as a pump and a transfer pipe.

The system may comprise a plurality of interconnected wastewater tanks 22 each containing at least one filter device 20.

In the wastewater tank 22, there may be a height difference between the side of the liquid-permeable filter element 40 that includes the wastewater 8 and the side of the at least one liquid-permeable filter element 40 that contains the filtrate 26. As seen in FIGS. 1-3, the level 28 of the wastewater 8 in the wastewater tank 22 is provided and is higher than the level 38 of the filtrate 26 in the wastewater tank 22. The “filtrate” 26 is the wastewater 8 after it has been filtered by the at least one liquid-permeable filter element 40, thereby removing filterable solids of the wastewater 8. This height difference is typically about 25 cm or 0.025 bar. This height difference may aid in maintaining the continuous filtration of the wastewater 8 through the at least one liquid-permeable filter element 40. The filterable solids may be continuously deposited on the first side 84 of the at least one liquid-permeable filter element 40 of the filter device 20, creating the cake layer 36 of filterable solids that increases in thickness as more filterable solids is deposited.

The at least one liquid-permeable filter element 40 may be sprayed with a liquid, such as a filtrate 26, to remove or aid in the removal of a cake layer 36 from the first side 84 of the at least one liquid-permeable filter element 40 that forms from the deposition of filterable solids onto the first side 84 of the at least one liquid-permeable filter element 40.

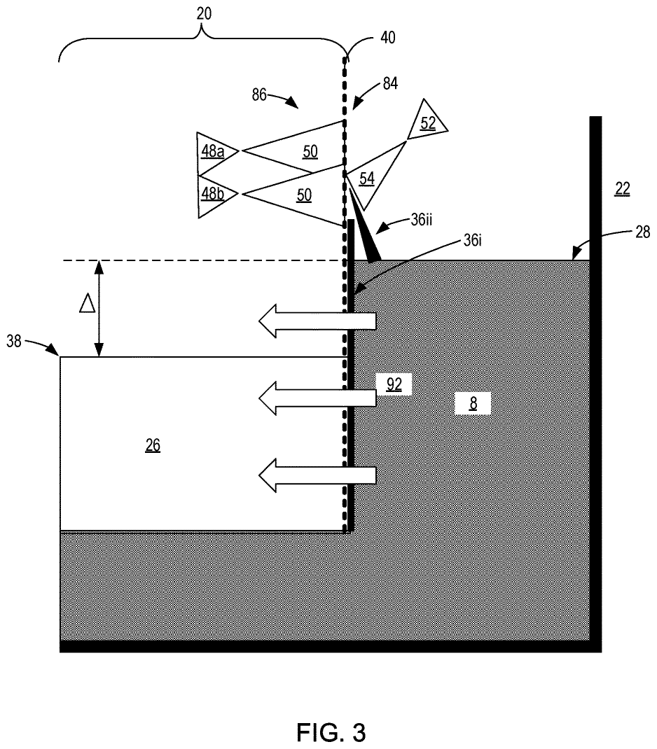

For example, referring to FIG. 3, the system may include a backwash system that includes at least one orifice that is configured to emit a spray of fluid (e.g., backwash water) in the direction of the at least one liquid-permeable filter element 40. For example, the system may comprise at least one second orifice (backwash orifice) 48a, 48b that emits a spray 50 of fluid at the second side 86 of the filter element 40, through the filter element 40, and towards the first side 84 of the at least one liquid-permeable filter element 40 to remove and/or aid in the removal of the cake layer 36 formed on the first side 84 of the at least one liquid-permeable filter element 40. FIG. 3 shows the cake layer 36 in its form adhered to the first side as adhered cake layer 36i and as it is reintroduced into the wastewater 8 after being dislodged from the first side 84 as removed cake layer 36ii. The system may comprise at least one first orifice (surface wash orifice) 52 that emits a spray 54 of fluid at the first side 84 of the liquid-permeable filter element 40. The fluid provided by the first and/or second 52, 48a, 48b orifice(s) may be any liquid known in the art. For example, said fluid provided by the first and/or second orifice 52, 48a, 48b may be a liquid, such as a portion of the filtrate 26. Alternatively, said fluid provided by the first and/or second orifice 52, 48a, 48b may be a gas. The orifices 52, 48a, 48b may be made of stainless steel. The orifices 52, 48a, 48b may be made of plastic.

In the case of a rotating filter device 20, said rotating filter device 20 may rotate at 0.1 to 20 rpm, such as from 0.1 to 3 rpm, from 0.1 to 2.5 rpm, from 0.1 to 1.0 rpm, so as to additionally aid in the deposition of the filterable solids on the liquid-permeable filter element 40 of the rotating filter device 20. The cake layer 36 may be deposited, grown, and thickened in the time of one revolution of the rotating filter device 20.

The at least one liquid-permeable filter element 40 of the filter device 20 may remove the suspended filterable solids from the wastewater 8, thus producing a clear, liquid filtrate 26. The cake layer 36 may remain on the first side 84 of the at least one liquid-permeable filter element 40 until removed.

The at least one liquid-permeable filter element 40 may have a specified pore size. For example, contrary to membrane filters which typically have a pore size of larger than 0.1 μm, the pore size of the at least one liquid-permeable filter element 40 may be in the range of from 1 to 40 μm, such as 2 to 30 μm, or less than 20 μm.

The filter device 20 may have a flux of greater than 200 L/m²h, or greater than 500 L/m²h, or greater than 1,000 L/m² h across the at least one liquid-permeable filter element 40.

The filter device 20 may have a flux of up to 5,000 L/m²h, or up to 4,000 L/m²h, or up to 3,000 L/m² h across the at least one liquid-permeable filter element 40. It is a low energy solution.

The filter device 20 may operate within the wastewater 8. The wastewater 8 may travel through the cake layer 36 and the liquid-permeable filter element 40 and collect on the opposite side of the liquid-permeable filter element 40 as a filtrate 26 where it may then be transferred to external to the filter device 20. The cake layer 36 that is deposited on the first side 84 of the liquid-permeable filter element 40 of the filter device 20 may be removed by backwash the second side 86 of the liquid-permeable filter element 40. For example, water, such as the filtrate 26, may be applied from a second orifice 48a, 48b to the second side 86 of the at least one liquid-permeable filter element 40, such that the liquid goes through the at least one liquid-permeable filter element 40 and towards the first side 84 of the at least one liquid-permeable filter element 40, thereby allowing the cake layer 36 to be more readily removed from the first side 84 of the liquid-permeable filter element 40.

The cake layer 36 may be removed from the first side 84 of the liquid-permeable filter element 40 and returned into the wastewater 8 where said cake layer 36 may combine with an amount of the wastewater 8 to produce a slurry 30. The filter device 20 may operate at a TSS content in the wastewater 8 of at least 200 mg/L, or at least 5,000 mg/L, or at least 10,000 mg/L. The filter device 20 may operate at a TSS content in the wastewater 8 of up to 50,000 mg/L, or up to 35,000 mg/L, or up to 20,000 mg/L. For example, the filter device 20 may operate at a TSS content of the wastewater 8 ranging from 10,000-20,000 mg/L.

For example, the rotating filter device 20 may be implemented at said TSS content levels. For example, the rotating filter device 20 may comprise at least one liquid-permeable filter element 40 that includes a first side 84 and a second side 86 opposite of the first side 84. The cake layer 36 that forms from the filtering of the wastewater 8 may form on the first side 84 of the at least one liquid-permeable filter element 40. The wastewater 8 may deliberately foul the at least one liquid-permeable filter element 40, thereby forming the cake layer 36 on the first side 84 of the at least one liquid-permeable filter element 40 and also a filtrate 26 which passed through the at least one liquid-permeable filter element 40. A liquid, such as the filtrate 26, may be sprayed at the at least one liquid-permeable filter element 40 to remove and/or aid in the removal of the cake layer 36 from the first side 84 of the liquid-permeable filter element 40. For example, a second orifice 48a, 48b may emit a spray 50 of fluid at the second side 86 of the at least one liquid-permeable filter element 40. A first orifice 52 may emit a spray 54 of fluid at the first side 84 of the at least one liquid-permeable filter element 40. For example, said fluid provided by the first and/or second orifice 52, 48a, 48b may be a liquid, such as a portion of the filtrate 26. Alternatively, said fluid provided by the first and/or second orifice 52, 48a, 48b may be a gas. A portion of the first side 84 of the at least one liquid-permeable filter element 40 may be subject to the wastewater 8 under pressure where the pressure across said portion of the first side 84 is greater than 0 and less than or equal to 5.9 kPa when the at least one liquid-permeable filter element 40 is in a first position which is at least partially submerged in the wastewater 8. In a second position, wherein the at least one liquid-permeable filter element 40 is no longer submerged in the wastewater 8, the first side 84 of the at least one liquid-permeable filter element 40 is not subject to wastewater 8 under pressure or is subject to wastewater 8 at a lower pressure than in the first position. The rotating filter device 20 may include at least one second orifice 48a, 48b that directs at least one spray 50 of fluid at the second side 86 of the at least one liquid-permeable filter element 40, through the at least one liquid-permeable filter element 40, and towards the first side 84 of the at least one liquid-permeable filter element 40 to remove and/or aid in the removal of the cake layer 36. A first orifice 52 may emit a spray 54 of fluid at the first side 84 of the at least one liquid-permeable filter element 40. For example, said fluid provided by the first and/or second orifice 52, 48a, 48b may be a liquid, such as a portion of the filtrate 26. Alternatively, said fluid provided by the first and/or second orifice 52, 48a, 48b may be a gas. Software and physical performance enhancers may also be implemented to increase the efficiency of the filter device 20. For example, the speed of rotation of the at least one liquid-permeable filter element 40 and the backwashing parameters may be operated at lower intensity, compared to the biological treatment process of the rotating filter device 20.

The at least one liquid-permeable filter element 40 of the filter device 20 may have an optimized pore size, such as a pore size in the range of 2 to 40 μm.

As previously stated, the cake layer 36, formed from the filterable solids that was suspended in the wastewater 8 prior to filtering may be removed from the first side 84 of the at least one liquid-permeable filter element 40 and reintroduced into the wastewater 8 (see cake layer 36ii). When reintroduced into the wastewater 8, the cake layer 36 may be combined with an amount of the wastewater 8 to form a slurry 30. For example, backwashing of the at least one liquid-permeable filter element 40 may aid in the removal of the cake layer 36 by applying a spray 50 of a fluid to the second side 86 of the at least one liquid-permeable filter element 40 from a second orifice 48a, 48b, thereby penetrating the at least one liquid-permeable filter element 40. Additionally or alternatively, the second orifice 48a, 48b may apply a spray 50 of gas to the second side 86 of the at least one liquid-permeable filter element 40. Once the cake layer 36 is separated from the first side 84 of the at least one liquid-permeable filter element 40, gravity may reintroduce the cake layer 36 into the wastewater 8, thus forming slurry 30.

The slurry 30 may be collected and removed from the wastewater tank 22 by any suitable process. For example, the slurry 30 may be removed by pumping the slurry 30 with a pump through pipe(s) to a waste to energy system 32. The slurry 30 may be continuously removed from the wastewater tank 22 (e.g., by overflow), or the slurry 30 may be periodically removed from the wastewater tank 22 via a batch process.

The filtrate 26 may also be removed from the wastewater tank 22 with a transportation apparatus.

Referring to FIGS. 3-10, non-limiting embodiments or aspects of a backwash system for use in a solid-liquid separation system (e.g., a wastewater treatment system) are shown. The backwash system may comprise the filter device 20 having liquid-permeable filter elements 40. The filter elements 40 may be configured to separate a solid-liquid containing stream into the filtrate 26 component and a solids component comprising a sludge component (previously the filterable solids of which the cake layer 36 is formed). The solid-liquid stream may comprise wastewater and/or a mixed liquor stream of secondary biological treatment systems. The filtrate 26 may comprise filtered water cleaner than the water component in the wastewater 8.

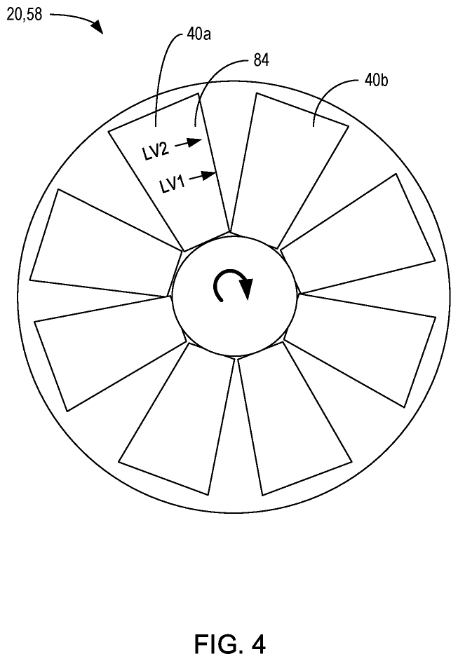

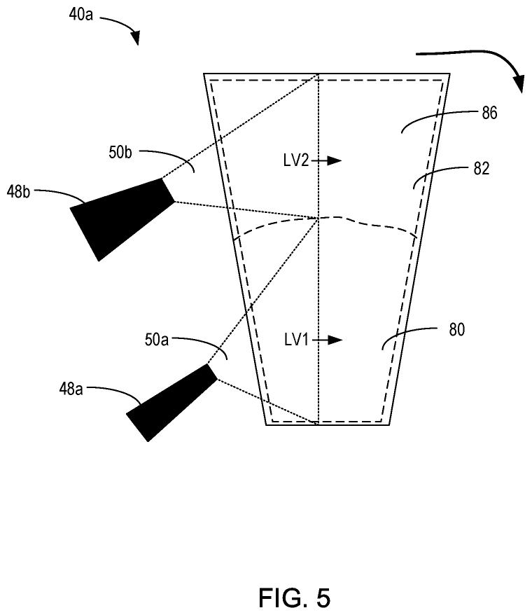

Referring to FIGS. 4-5, the filter device 20 may be a rotating filter. The filter device 20 may rotate around a rotation point and may have a perimeter defining and end thereof. The filter device 20 may rotate in the clockwise or counterclockwise direction. The filter device 20 may comprise filter elements 40a, 40b for filtering the wastewater 8. The filter device 20 may be a rotating disc 58 so as to rotate the filter elements 40a, 40b. The filter device 20 may comprise a single filter element 40, or, as shown in the non-limiting example of FIG. 4, the filter device 20 may comprise a plurality of filter elements 40a, 40b.

Referring to FIG. 4, a non-limiting example in which the filter device 20 is a rotating disc filter is shown. The filter device 20 may be in the shape of a disc 58 comprising a plurality of filter elements 40a, 40b about the area of the disc 58. The disc 58 may rotate, such as in the clockwise direction as shown in FIG. 4. The disc 58 may be circular or substantially circular. By substantially circular, it is meant that the disc 58 has a relatively rounded perimeter. Shapes that may be considered substantially circular in the context of this disclosure includes discs 58 that are circular, oval, at least pentagonal, at least hexagonal, or at least octagonal. In some non-limiting embodiments, the filter device 20 may be in the shape other than a circular disc, such as a square, a rectangle, a triangle, or any other suitable shape.

Referring to FIG. 4, the rotating filter device 20 may be substantially vertical relative to the ground. By substantially vertical, it is meant that the rotating filter is within 30° of a line perpendicular to the ground, such as within 15°, within 10°, within 5°, or 0°.

Referring again to FIGS. 4-5, the filter elements 40a, 40b may have a trapezoidal shape as shown or be of any other suitable shape. Based on the disc 58 shape of the rotating filter device 20, the linear velocity of the filter elements 40a, 40b may change in the radial direction of the disc 58. For example, a first region 80 of the filter element 40a closer to the center point of the disc 58 may have a lower linear velocity LV1 compared to the linear velocity LV2 at a second region 82 of the filter element 40a radially farther from the center point of the disc 58. It will be appreciated that the angular velocity may be identical while the linear velocity may increase moving radially outward from the rotation point of the disc 58. Due to the differences in linear velocity in the radial direction, it will be appreciated that backwash orifices emitting backwash water at different radial regions of the filter element 40a at the same flow rate will emit the backwash water at a different backwash intensity (accounting also for area covered) over the filter element 40a. Flow rate refers to the L/min at which backwash water is emitted from backwash orifices, while backwash intensity refers to the L/min/m² at which the backwash water is incident to a region of the filter element 40a.

Referring to FIG. 5, the backwash system may comprise a plurality of backwash orifices (second orifices 48a, 48b) configured to emit sprays 50a, 50b of backwash water (e.g., at the second side 86 (from FIG. 3)) of the filter element 40 so as to remove at least a portion of the cake layer 36 (not shown) therefrom. The plurality of second backwash orifices 48a, 48b may comprise a first second orifice 48a and a second second orifice 48b, as shown in FIG. 5. These second orifices 48a, 48b may be arranged to emit sprays 50a, 50b of the backwash water at different regions (e.g., the first region 80 and the second region 82) of the filter element 40. These different regions 80, 82 may be partially overlapping or may not overlap. The first region 80 may be closer to the rotation point of the filter device 20 than the second region 82. The surface area of the first region 80 may be less than the surface area of the second region 82. While two orifices, sprays and regions are shown, it will be appreciated that any number of orifices, sprays or regions may be used.

The first second orifice 48a may emit a spray 50a of backwash water at the first region 80 at a first flow rate, while the second second orifice 48b may emit a spray 50b of backwash water at the second region 82 at a second flow rate different from the first flow rate. The first flow rate emitted by the first second orifice 48a may be lower than the second flow rate emitted by the second second orifice 48b. The second second orifice 48b may emit backwash water at the second region 82 and the first second orifice 48a may emit backwash water at the first region 80 such that the second region 82 experiences a higher backwash intensity (in L/min/m²) than the first region 80. Contacting the second region 82 at a higher flow rate than the first region 80 contributes to ensuring that the backwashing process will sufficiently clean all regions 80, 82 of the filter element 40 in an energy efficient manner.

With continued reference to FIG. 5, the second second orifice 48b is shown as being larger than the first second orifice 48a to emphasize the higher flow rate emitted by the second second orifice 48b at the second region 82 compared to the first region 80. For example, an opening of the second second orifice 48b may be larger than an opening of the first second orifice 48a. It will be appreciated that the second second orifice 48b will emit the spray 50b of backwash water at a higher flow rate than the first second orifice 48a if it is desired to have a higher backwash intensity in the second region 82 compared to the first region 80 due to the linear velocity LV2 in the second region 82 being higher than the linear velocity LV1 in the first region 80 when the filter is rotated. In this way, a greater area may be covered by the second second orifice 48b in the second region 82 compared to the area covered by the first second orifice 48a in the first region 80 in the same amount of time. While the non-limiting example in FIG. 5 shows two second orifices 48a, 48b, it will be appreciated that more may be used, and the arrangement of those second orifices 48a, 48b may be selected so as to have a higher backwash intensity in the second region 82 (farther from the rotation point) compared to the first region 80. Because larger orifices may be used in regions having higher area to clean, the pump used to pump the backwash water may be operated at lower pressure, therefore reducing energy consumption, and thus operational costs. This is in contrast to using relatively smaller orifices for regions having relatively larger areas, which require the pump to operate at higher pressures, and thus consume higher energy and operational costs.

The second orifices 48a, 48b may be configured to have any size to effect the flow rates required to meet at least the minimum backwash intensity. In one non-limiting example, the first second orifice 48a has a 1.0 to 1.5 mm opening while the second second orifice 48b has a 1.5 to 2.0 mm opening so that the first second orifice 48a emits a lower flow rate of backwash water than the second second orifice 48b, assuming a constant water pressure. In one non-limiting example, the first second orifice 48a has a flow rate of from 1-2 L/min while the second second orifice 48b has a flow rate of from 2-4 L/min.

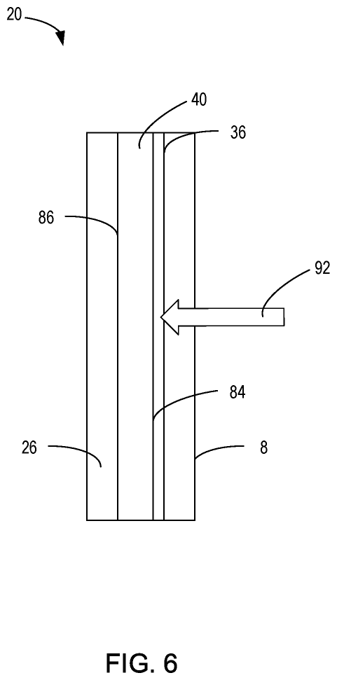

Referring to FIGS. 3 and 6, the filter element 40 may comprise a layer of the sludge component (e.g., the cake layer 36) formed on a surface (e.g., the first side 84 thereof). The cake layer 36 on the first side 84 of the filter element 40 may be formed by flowing wastewater 8 in the flow direction 92 indicated in FIG. 6 toward the first side 84. At least a portion of the water from the wastewater 8 may flow through the filter element 40 (in through the first side 84 and out through the second side 86) to form the filtrate 26 comprising filtered water. The filter element 40 may prevent at least a portion of the sludge component from penetrating therethrough, such that that the sludge component is adhered to the first side 84 to form the cake layer 36. The second orifices 48a, 48b (not shown) may be arranged to emit the backwash water at the cake layer 36 so as to remove at least a portion of the cake layer 36 from the first side 84. At least one second orifices 48a, 48b may emit backwash water at the second side 86, which second side 86 is in contact with the filtrate 26. Using the second orifices 48a, 48b to contact the opposing second side 86 may help remove the cake layer 36 from the first side 84 by the backwash water therefrom contacting the cake layer 36 at its interface with the first side 84 after penetrating through the second side 86.

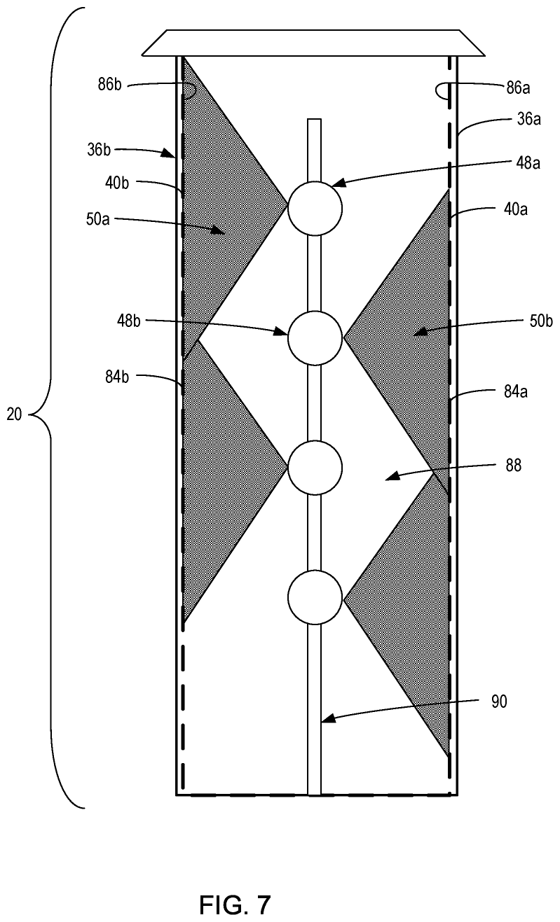

Referring to FIG. 7, a non-limiting example of a filter device 20 is shown. The filter device 20 may include a plurality of opposite facing filter elements 40a, 40b separated by a gap 88. The filter elements 40a, 40b may be encased in filter device 20. The filter device 20 may include a first filter element 40a having a first side 84a and a second side 86a and a second filter element 40b having a first side 84b and a second side 86b. The first sides 84a, 84b may be facing opposite directions and may be exterior surfaces of the filter device 20, such that they are in contact with a solid-liquid stream. The second sides 86a, 86b may be interior surfaces of the filter device 20, such that they are in contact with filtrate, and the second sides 86a, 86b may be distanced by the gap 88. A backwash pipe 90 may be disposed in the gap 88 to carry backwash water to a plurality of second orifices 48a, 48b. The second orifices 48a, 48b may emit sprays 50a, 50b of backwash water at the second sides 86a, 86b to dislodge a cake layer 36a, 36b on the first sides 84a, 84b.

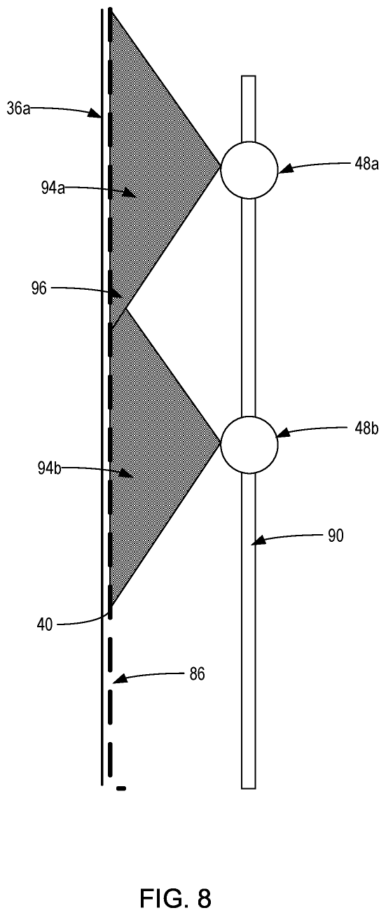

Referring to FIG. 8, a schematic view of a backwash pipe 90 having second backwashing orifices 48a, 48b emitting backwash water at the second side 86 of the filter element 40 is shown. The backwashing orifices 48a, 48b may be directly perforated on the same backwashing pipe 90 at different vertical heights. It will be appreciated that more than the two backwashing orifices 48a, 48b shown in FIG. 8 may be directly perforated on the backwashing pipe 90. The perforations may be perforated holes, perforated slots, and/or the like. The backwash orifices 48a, 48b may comprise nozzles. The nozzles may be configured to control spray angle, spray pattern, spray distribution, and/or the like. The backwashing orifices 48a, 48b may emit backwash water at the second side 86 so as to form non-overlapping regions 94a, 94b and an overlapping region 96. In the overlapping region 96, the second side 86 may be hit with backwash water emitted from a plurality of backwashing orifices 48a, 48b. In the non-overlapping regions 94a, 94b, the second side 86 may be hit with backwash water emitted from a single backwashing orifice (48a and 48b, respectively). The backwash intensity in the overlapping region 96 may be higher than the backwash intensity in the adjacent non-overlapping regions 94a, 94b.

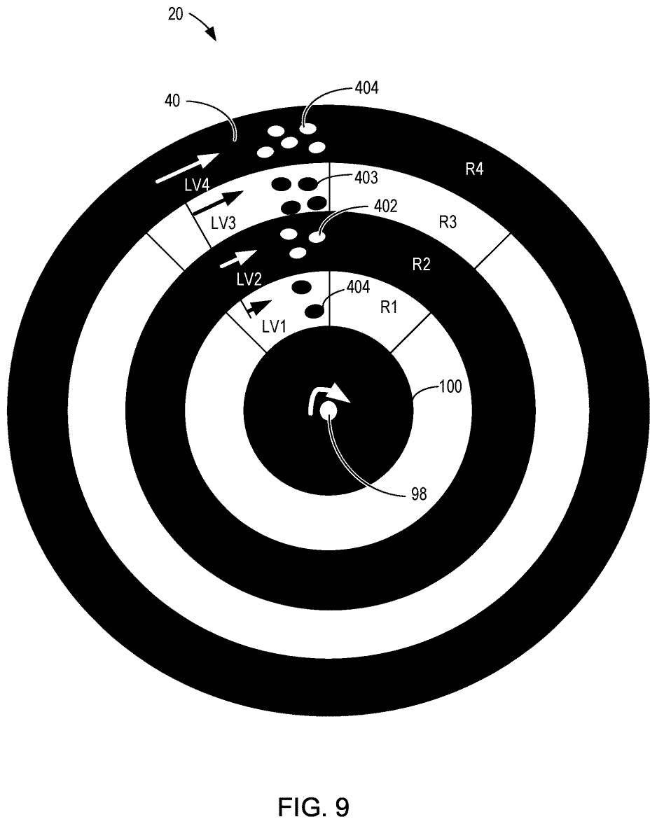

Referring to FIG. 9 a non-limiting example of a rotating filter device 20 in the form of a drum 100 is shown, which filter has four orifices (not shown) emitting backwash water at the filter device 20 (e.g., filter elements 40 thereof). The filter device 20 rotates in a clockwise direction as shown. The filter device 20 may rotate around a rotation point 98. The filter device 20 shown in this non-limiting example has four regions R1-R4 forming bands around the circular filter, and each region is contacted with backwash water from a different orifice, each band having a larger surface area moving away from the center (rotation point 98). As the filter device 20 rotates, the linear velocity LV1-LV4 in each region R1-R4 increases as the region gets farther away from the rotation point 98.

In this non-limiting example, a first orifice has a 1.2 mm orifice emitting backwash water at the first region R1. A second orifice has a 1.3 mm orifice emitting backwash water at the second region R2. A third orifice has a 1.5 mm orifice emitting backwash water at the third region R3. A fourth orifice has a 1.9 mm orifice emitting backwash water at the fourth region R4. The areas 401-404 of the filter elements 40 covered by the orifices emitting backwash water at the regions R1-R4 are shown. The backwash water may flow to the four orifices at a same pressure. Thus, the flow rate of backwash water emitted from the fourth orifice is higher than the flow rate of backwash water emitted from the third orifice, which is higher than the flow rate of backwash water emitted from the second orifice, which is higher than the flow rate of backwash water emitted from the first orifice. Filtrate flowing through the regions R1-R4 of the filter element 40 may flow vertically downward and into the drum 100, where the filtrate is collected and leaves the system.

With continued reference to FIG. 9, the backwash intensity experienced by regions farther from the rotation point 98 may be higher compared to regions 98 closer to the rotation point 98. For example, the backwash intensity experienced by a portion of the fourth region R4 may be higher than the backwash intensity experienced by the third region R3. Having a higher backwash intensity at regions farther from the rotation point 98 may enable better and more efficient cleaning of the filter device 20. For the filter device 20, the backwash intensity as a function of distance from the rotation point 98 may be calculated. The filter device 20 may be designed with the backwash orifices configured and arranged such that a slope of a line denoting backwash intensity as a function of distance from the rotation point 98 is greater than or equal to −2 liter/min/m³, such as greater than or equal to −1, greater than or equal to −0.5, greater than or equal to 0, greater than or equal to 0.2, greater than or equal to 0.5, greater than or equal to 1, or greater than or equal to 2. The line may be generated as a best fit line based on data points modeling or reporting the backwash intensities at different distances from the rotation point 98. The best fit line may be generated using any statistical method known to those skilled in the art, such as by using the best fit line (e.g., trend line) function in Microsoft Excel.

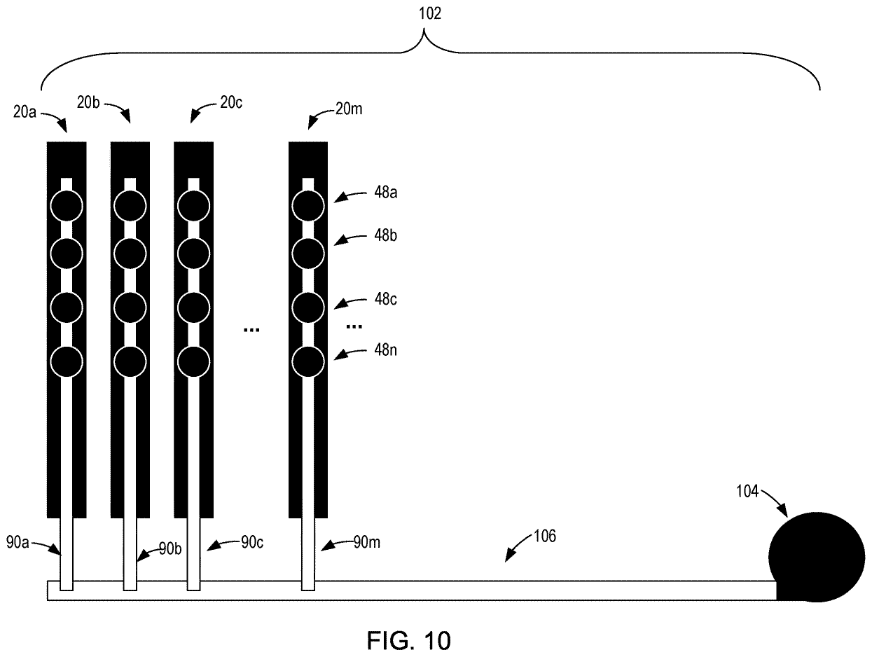

Referring to FIG. 10, a solid-liquid treatment unit 102 is shown according to some non-limiting embodiments or aspects. The unit 102 may include a plurality of filter devices 20a-20m as described herein. The unit 102 also include a pump system comprising a backwash pump 104 and piping 106 in fluid communication with the filters 20a-20m. For example, the piping 106 may be in fluid communication with the backwash pipes 90a-90m. The backwash pump 104 may be configured to pump backwash water through the piping 106 and to the backwash pipes 90a-90m. From the backwash pipes 90a-90m, the backwash water may be emitted through a plurality of orifices 48a-48n vertically arranged in each of the filter devices 20a-20m. Each orifice 48a-48n may be a hole formed in the backwash pipes 90a-90m from which backwash water may be emitted, or each orifice 48a-48n may comprise a nozzle which may be a separate component from the backwash pipes 90a-90m which emits backwash water from the backwash pipes 90a-90m and contains an orifice from which the backwash water may be emitted.

With continued reference to FIG. 10, the pressure of the backwash water pumped to each of the filter devices 20a-20m (e.g., through backwash pipes 90a-90m thereof) may be substantially uniform. By substantially uniform, it is meant that the flowrate of the backwash water flowing through the backwash pipe 90a of the first filter device 20a is within 25% deviation relative to the flowrate of the backwash water flowing through the backwash pipe 90m of the m^{th} filter device 20m or any other backwash pipe (e.g., 90b, 90c) in the unit 102, such as within 20%, within 15%, within 10%, or within 5%. The pressure of the backwash water in the backwash pipes 90a-90m may range from 1-10 bars, such as from 2-5 bars.

The present disclosure is also directed to a method for cleaning a filter in a solid-liquid treatment system. Referring again to FIGS. 4-10, the method may include arranging a plurality of backwash orifices (e.g., the backwash orifices 48a, 48b) to emit backwash water at the rotating filter device 20. The rotating filter device 20 may have a rotation point 98 around which the rotating filter device 20 rotates and a perimeter defining an end of the filter device 20. The filter elements 40 of the filter device 20 may be configured to separate a solid-liquid containing stream (e.g., a wastewater stream) into a filtrate component (e.g., filtered water) and a solids component (e.g., a sludge component). The filter element 40 may comprise a layer of the solids component on a surface thereof. The method may include emitting the backwash water from the plurality of backwash orifices 48a, 48b at the filter device 20 so as to remove at least a portion of the layer of the solids component from the surface. The plurality of backwash orifices 48a, 48b may be respectively arranged to emit the backwash water at the first region 80 and second region 82 of the filter device 20, such that the second region 82 (farther from the rotation point 98 of the filter device 20) experiences a higher backwash flow rate than the first region 80.

Referring to FIGS. 4 and 5, the filter device 20 may be rotated (e.g., as part of a rotating disc 58 as shown in FIG. 4). For example, the filter element 40 may be rotated such that the linear velocity LV1 in the first region 80 is lower than the linear velocity LV2 in the second region 82.

Referring to FIGS. 3 and 5, the method may further include arranging a plurality of second backwash orifices 48a, 48b at the second side 86 of the filter device 20 and emitting backwash water from the at least one second backwash orifice 48a, 48b at the second side 86. At least one first orifice 52 may emit backwash water at the solids component on the first side 84.

With continued reference to FIG. 3, the method may include arranging the filter device 20 in a wastewater tank 22 and filling the wastewater tank 22 with a solid-liquid containing stream (e.g., wastewater 8). The method may include separating a filtrate 26 from the solid-liquid containing stream by rotating the filter device 20, where the filtrate 26 comprises filtered water. The filtered water may be collected and removed from the wastewater tank 22. The method may include collecting a portion of the solids component (e.g., sludge component) removed from the surface of the filter element 40. The collected solids component may be removed from the wastewater tank 22 in which the filter device 20 is arranged.

### EXAMPLES

### Examples 1-16

### Comparing Disc Systems

Two rotating disc filter systems (activated sludge filters) were fitted with sets of backwash orifices. The first Disc System (DS1) is the original design. DS1 had two 1 mm orifices installed at different radial distances from the center of the disc. The second Disc System (DS2) is an optimized orifice design according to the present disclosure. DS2 also had two orifices installed at the same radial distances, but the orifice closer to the center of the disc had a 1.2 mm orifice, while the orifice farther from the center of the disc had a 1.7 mm orifice.

Both DS1 and DS2 were tested for wastewater treatment. During an approximately 10 day period, 7 events were randomly selected over that time period to compare the DS1 and the DS2 based on solid flux performance. Solids flux is calculated as flux times mixed liquor suspended solids (MLSS) concentration. Solids flux is a useful indicator for comparison, because DS1 and DS2 may not be operated at the same MLSS concentration, and previous tests demonstrated that flux is lower when MLSS concentration is higher.

Based on BW kwh energy/m³ water filter and mainly on solids flux, 6 of the events showed the DS2 outperforming the DS1, 1 event showed the DS1 performed better than DS2. Detailed calculations are shown in Table 1.

Although DS1 and DS2 are similar systems, some unknown aspects of DS1 and DS2 may affect this comparison. DS2 may inherently perform better than DS1 irrelevant to the backwash nozzles configuration. To eliminate the inherent performance differences between DS1 and DS2 and make the comparisons more persuasive, orifice design was switched.

During another 3-week period, DS2 was switched to the original orifice design with two 1 mm orifices. DS1 was switched to the optimized orifice design with two orifices of 1.2 mm and 1.7 mm. Table 2 and Table 3 show this change and results. 9 events were randomly selected over that time period to compare the DS1 and the DS2 based on solid flux performance. 7 of the events showed the DS1 outperforming the DS2, 1 event showed the DS2 and DS1 performed similarly. 1 event showed the DS2 outperformed DS1.

Therefore, among the 16 events, 13 events showed that the system with optimized orifice design outperformed the system without optimized orifice design. 1 event showed that the system with optimized orifice design and the system without optimized orifice design performed similarly. 2 events showed that the system with optimized orifice design performed not as well as the system without optimized orifice design.

Overall, it was found that the system using optimized orifice design at different radial distances showed improved performance compared to the system that used the same orifice size at different radial distances. Comparable backwash power was consumed by the DS1 and the DS2 within each event. The following Tables 1-3 show the relevant results.

Backwash energy conversion was calculated using the following equation: Backwash Energy (kW)=[Backwash Flow (m³/h)*Backwash Pressure (Pa)]/3.6×10\hat{ }6

Specific Backwash Energy was calculated using the following equation: Specific Backwash Energy (kWh/m³)=Backwash Energy (kW)/Filtrate Flow (m³/h).

TABLE 1

| | Event 1 | | Event 2 | | Event 3 | | Event 4 | |
|---|---|---|---|---|---|---|---|---|
| | DS1 | DS2 | DS1 | DS2 | DS1 | DS2 | DS1 | DS2 |
| Orifice | 1.0/1.0 | 1.2/1.7 | 1.0/1.0 | 1.2/1.7 | 1.0/1.0 | 1.2/1.7 | 1.0/1.0 | 1.2/1.7 |
| (mm) | | | | | | | | |
| Event | 6.85 | 6.75 | 6.25 | 6.37 | 33.32 | 33.25 | 6.93 | 6.77 |
| Duration | | | | | | | | |
| (h) | | | | | | | | |
| Filtrate | 9.74 | 13.07 | 7.70 | 10.84 | 4.49 | 5.54 | 8.85 | 9.57 |
| Flow | | | | | | | | |
| (m3/hr) | | | | | | | | |
| Backwash | 42.44 | 29.43 | 43.27 | 29.40 | 21.69 | 14.71 | 45.07 | 29.02 |
| Pressure | | | | | | | | |
| (psi) | | | | | | | | |
| Backwash | 1.34 | 1.99 | 1.37 | 1.98 | 1.14 | 1.50 | 1.42 | 2.00 |
| Flow | | | | | | | | |
| (m3/hr) | | | | | | | | |
| Disk | 2.36 | 2.35 | 1.02 | 1.03 | 0.26 | 0.27 | 2.00 | 2.00 |
| Rotation | | | | | | | | |
| Speed | | | | | | | | |
| (rpm) | | | | | | | | |
| MLSS | 10160 | 8980 | 10955 | 10760 | 10955 | 9745 | 12005 | 11620 |
| (mg/L) | | | | | | | | |
| Flux | 2898 | 3890 | 2291 | 3226 | 1336 | 1650 | 2634 | 2849 |
| (l/m2/h) | | | | | | | | |
| Solid | 29.45 | 34.93 | 25.10 | 34.71 | 14.64 | 16.08 | 31.62 | 33.10 |
| Flux | | | | | | | | |
| (kg/m2/ | | | | | | | | |
| h) | | | | | | | | |
| Backwash | 0.109 | 0.112 | 0.113 | 0.112 | 0.047 | 0.042 | 0.123 | 0.111 |
| Energy | | | | | | | | |
| (kw) | | | | | | | | |
| Specific | 0.011 | 0.009 | 0.015 | 0.010 | 0.011 | 0.008 | 0.014 | 0.012 |
| BW | | | | | | | | |
| Energy | | | | | | | | |
| (kWh/ | | | | | | | | |
| m3 | | | | | | | | |
| water | | | | | | | | |
| treated) | | | | | | | | |
| Specific | 0.0037 | 0.0032 | 0.0045 | 0.0032 | 0.0032 | 0.0026 | 0.0039 | 0.0034 |
| BW | | | | | | | | |
| Energy | | | | | | | | |
| kWh/ | | | | | | | | |
| m2/kg | | | | | | | | |
| solids | | | | | | | | |
| treated | | | | | | | | |
| Conclusion | −30.3% | 23.3% | −42.8% | 30.0% | −38.2% | 27.6% | −19.0% | 16.0% |
| based | | | | | | | | |
| on | | | | | | | | |
| Filtrate | | | | | | | | |
| Flow | | | | | | | | |
| Conclusion | −15.2% | 13.2% | −40.3% | 28.7% | −22.9% | 18.6% | −15.2% | 13.2% |
| based | | | | | | | | |
| on | | | | | | | | |
| Solid | | | | | | | | |
| Flux | | | | | | | | |
| Performance | | Better | | Better | | Better | | Better |

| | Event 5 | | Event 6 | | Event 7 | |
|---|---|---|---|---|---|---|
| | DS1 | DS2 | DS1 | DS2 | DS1 | DS2 |
| Orifice | 1.0/1.0 | 1.2/1.7 | 1.0/1.0 | 1.2/1.7 | 1.0/1.0 | 1.2/1.7 |
| (mm) | | | | | | |
| Event | 41.42 | 41.63 | 25.92 | 26.88 | 30.30 | 30.22 |
| Duration | | | | | | |
| (h) | | | | | | |
| Filtrate | 4.21 | 5.07 | 7.22 | 9.27 | 3.22 | 2.87 |
| Flow | | | | | | |
| (m3/hr) | | | | | | |
| Backwash | 44.75 | 28.28 | 49.55 | 28.41 | 30.71 | 19.07 |
| Pressure | | | | | | |
| (psi) | | | | | | |
| Backwash | 1.45 | 1.99 | 1.42 | 2.00 | 1.24 | 1.68 |
| Flow | | | | | | |
| (m3/hr) | | | | | | |
| Disk | 0.26 | 0.27 | 2.63 | 2.36 | 0.26 | 0.27 |
| Rotation | | | | | | |
| Speed | | | | | | |
| (rpm) | | | | | | |
| MLSS | 11738 | 9830 | 11780 | 11420 | 11780 | 10400 |
| (mg/L) | | | | | | |
| Flux | 1252 | 1508 | 2149 | 2760 | 958 | 854 |
| (l/m2/h) | | | | | | |
| Solid | 14.70 | 14.82 | 25.31 | 31.52 | 11.29 | 8.88 |
| Flux | | | | | | |
| (kg/m2/ | | | | | | |
| h) | | | | | | |
| Backwash | 0.124 | 0.108 | 0.135 | 0.109 | 0.073 | 0.061 |
| Energy | | | | | | |
| (kw) | | | | | | |
| Specific | 0.029 | 0.021 | 0.019 | 0.012 | 0.023 | 0.021 |
| BW | | | | | | |
| Energy | | | | | | |
| (kWh/ | | | | | | |
| m3 | | | | | | |
| water | | | | | | |
| treated) | | | | | | |
| Specific | 0.0084 | 0.0073 | 0.0053 | 0.0035 | 0.0065 | 0.0069 |
| BW | | | | | | |
| Energy | | | | | | |
| kWh/ | | | | | | |
| m2/kg | | | | | | |
| solids | | | | | | |
| treated | | | | | | |
| Conclusion | −38.6% | 27.8% | −58.4% | 36.9% | −6.1% | 5.8% |
| based | | | | | | |
| on | | | | | | |
| Filtrate | | | | | | |
| Flow | | | | | | |
| Conclusion | −16.1% | 13.8% | −53.6% | 34.9% | 6.3% | −6.8% |
| based | | | | | | |
| on | | | | | | |
| Solid | | | | | | |
| Flux | | | | | | |
| Performance | | Better | | Better | Better | |

TABLE 2

| | Event 8 | | Event 9 | | Event 10 | |
|---|---|---|---|---|---|---|
| | DS1 | DS2 | DS1 | DS2 | DS1 | DS2 |
| Orifice | 1.2/1.7 | 1.0/1.0 | 1.2/1.7 | 1.0/1.0 | 1.2/1.7 | 1.0/1.0 |
| (mm) | | | | | | |
| Duration | 32.25 | 33.37 | 6.45 | 6.43 | 17.48 | 17.47 |
| (h) | | | | | | |
| Filtrate | 2.97 | 3.36 | 6.01 | 6.67 | 2.20 | 2.24 |
| Flow | | | | | | |
| (m3/hr) | | | | | | |
| Backwash | 28.77 | 18.57 | 30.60 | 48.34 | 30.65 | 47.11 |
| Pressure | | | | | | |
| (psi) | | | | | | |
| Backwash | 1.25 | 1.67 | 1.96 | 1.22 | 1.94 | 1.21 |
| Flow | | | | | | |
| (m3/hr) | | | | | | |
| Disk | 0.26 | 0.27 | 2.36 | 2.36 | 0.26 | 0.27 |
| Rotation | | | | | | |
| Speed | | | | | | |
| (rpm) | | | | | | |
| MLSS | 11010 | 11250 | 13865 | 8890 | 14720 | 13910 |
| (mg/L) | | | | | | |
| Flux | 884 | 999 | 1788 | 1985 | 656 | 666 |
| (l/m2/h) | | | | | | |
| Solid Flux | 9.74 | 11.24 | 24.80 | 17.64 | 9.66 | 9.26 |
| (kg/m2/h) | | | | | | |
| Backwash | 0.069 | 0.059 | 0.115 | 0.113 | 0.114 | 0.110 |
| Energy | | | | | | |
| (kw) | | | | | | |
| Specific | 0.023 | 0.018 | 0.019 | 0.017 | 0.052 | 0.049 |
| BW | | | | | | |
| Energy | | | | | | |
| (kWh/m3 | | | | | | |
| water | | | | | | |
| treated) | | | | | | |
| Specific | 0.0071 | 0.0053 | 0.0046 | 0.0064 | 0.0118 | 0.0118 |
| BW | | | | | | |
| Energy | | | | | | |
| kWh/m2/kg | | | | | | |
| solids | | | | | | |
| treated | | | | | | |
| Conclusion | −30.9% | 23.6% | −12.5% | 11.1% | −5.7% | 5.4% |
| based on | | | | | | |
| Filtrate | | | | | | |
| Flow | | | | | | |
| Conclusion | −33.7% | 25.2% | 27.9% | −38.6% | 0.1% | −0.1% |
| based on | | | | | | |
| Solid Flux | | | | | | |
| Performance | | Better | Better | | Similar | Similar |

| | Event 11 | | Event 12 | |
|---|---|---|---|---|
| | DS1 | DS2 | DS1 | DS2 |
| Orifice | 1.2/1.7 | 1.0/1.0 | 1.2/1.7 | 1.0/1.0 |
| (mm) | | | | |
| Duration | 5.65 | 5.68 | 60.45 | 60.20 |
| (h) | | | | |
| Filtrate | 5.38 | 5.36 | 1.81 | 2.05 |
| Flow | | | | |
| (m3/hr) | | | | |
| Backwash | 29.99 | 46.41 | 18.99 | 29.54 |
| Pressure | | | | |
| (psi) | | | | |
| Backwash | 1.93 | 1.22 | 1.63 | 1.01 |
| Flow | | | | |
| (m3/hr) | | | | |
| Disk | 2.00 | 2.06 | 0.26 | 0.27 |
| Rotation | | | | |
| Speed | | | | |
| (rpm) | | | | |
| MLSS | 14720 | 13910 | 14180 | 11550 |
| (mg/L) | | | | |
| Flux | 1600 | 1594 | 539 | 609 |
| (l/m2/h) | | | | |
| Solid Flux | 23.55 | 22.18 | 7.65 | 7.03 |
| (kg/m2/h) | | | | |
| Backwash | 0.111 | 0.108 | 0.059 | 0.057 |
| Energy | | | | |
| (kw) | | | | |
| Specific | 0.021 | 0.020 | 0.033 | 0.028 |
| BW | | | | |
| Energy | | | | |
| (kWh/m3 | | | | |
| water | | | | |
| treated) | | | | |
| Specific | 0.0047 | 0.0049 | 0.0078 | 0.0081 |
| BW | | | | |
| Energy | | | | |
| kWh/m2/kg | | | | |
| solids | | | | |
| treated | | | | |
| Conclusion | −1.8% | 1.7% | −17.4% | 14.8% |
| based on | | | | |
| Filtrate | | | | |
| Flow | | | | |
| Conclusion | 3.8% | −4.0% | 4.3% | −4.5% |
| based on | | | | |
| Solid Flux | | | | |
| Performance | Better | | Better | |

TABLE 3

| | Event 13 | | Event 14 | | Event 15 | | Event 16 | |
|---|---|---|---|---|---|---|---|---|
| | DS1 | DS2 | DS1 | DS2 | DS1 | DS2 | DS1 | DS2 |
| Orifice (mm) | 1.2/1.7 | 1.0/1.0 | 1.2/1.7 | 1.0/1.0 | 1.2/1.7 | 1.0/1.0 | 1.2/1.7 | 1.0/1.0 |
| Duration (h) | 75.13 | 75.42 | 22.28 | 22.17 | 5.70 | 5.83 | 15.45 | 60.39 |
| Filtrate Flow | 1.64 | 1.87 | 2.97 | 1.42 | 5.95 | 4.36 | 2.86 | 2.35 |
| (m3/hr) | | | | | | | | |
| Backwash | 20.01 | 34.46 | 23.21 | 48.50 | 32.06 | 47.63 | 30.32 | 46.37 |
| Pressure | | | | | | | | |
| (psi) | | | | | | | | |
| Backwash | 1.65 | 1.08 | 1.68 | 1.30 | 1.95 | 1.28 | 1.93 | 1.30 |
| Flow (m3/hr) | | | | | | | | |
| Disk | 0.26 | 0.27 | 0.26 | 0.27 | 2.36 | 2.36 | 1.02 | 1.14 |
| Rotation | | | | | | | | |
| Speed (rpm) | | | | | | | | |
| MLSS | 14180 | 11550 | 8050 | 5005 | 5410 | 5055 | 8295 | 9140 |
| (mg/L) | | | | | | | | |
| Flux (l/m2/h) | 487 | 556 | 884 | 421 | 1772 | 1296 | 851 | 701 |
| Solid Flux | 6.90 | 6.42 | 7.12 | 2.11 | 9.59 | 6.55 | 7.06 | 6.40 |
| (kg/m2/h) | | | | | | | | |
| Backwash | 0.063 | 0.071 | 0.075 | 0.121 | 0.120 | 0.117 | 0.112 | 0.116 |
| Energy (kw) | | | | | | | | |
| Specific BW | 0.039 | 0.038 | 0.025 | 0.085 | 0.020 | 0.027 | 0.039 | 0.049 |
| Energy | | | | | | | | |
| (kWh/m3 | | | | | | | | |
| water | | | | | | | | |
| treated) | | | | | | | | |
| Specific BW | 0.0092 | 0.0111 | 0.0105 | 0.0572 | 0.0125 | 0.0179 | 0.0159 | 0.0181 |
| Energy | | | | | | | | |
| kWh/m2/kg | | | | | | | | |
| solids | | | | | | | | |
| treated | | | | | | | | |
| Conclusion | −1.9% | 1.8% | 70.5% | −238.6% | 25.1% | −33.5% | 20.1% | −25.1% |
| based on | | | | | | | | |
| Filtrate Flow | | | | | | | | |
| Conclusion | 17.0% | −20.5% | 81.6% | −444.7% | 30.0% | −42.9% | 11.9% | −13.6% |
| based on | | | | | | | | |
| Solid Flux | | | | | | | | |
| Performance | Better | | Better | | Better | | Better | |

### Example 17

### Measuring Backwash Intensity as a Function of Distance from Rotation Point

A rotating disc filter was designed to include four different sized nozzles arranged between the rotation point of the disc and the edge of the disc. When hydraulic pressure at the backwash arm was 5 bar, the nozzle 593.8 mm above the rotation point had a nozzle diameter of 1.2 mm and a nozzle flow rate of 1.98 LPM. The second closest nozzle 711.9 mm above the rotation point had a nozzle diameter of 1.3 mm and a nozzle flow rate of 2.53 LPM. The third closest nozzle 833.2 mm above the rotation point had a nozzle diameter of 1.5 mm and a nozzle flow rate of 3.16 LPM. The farthest nozzle 951.9 mm above the rotation point had a nozzle diameter of 1.9 mm and a nozzle flow rate of 4.98 LPM. Each nozzle had a spray angle of 75°, and the horizontal distance between nozzles and the permeate size of the filtration mesh was 62 mm.

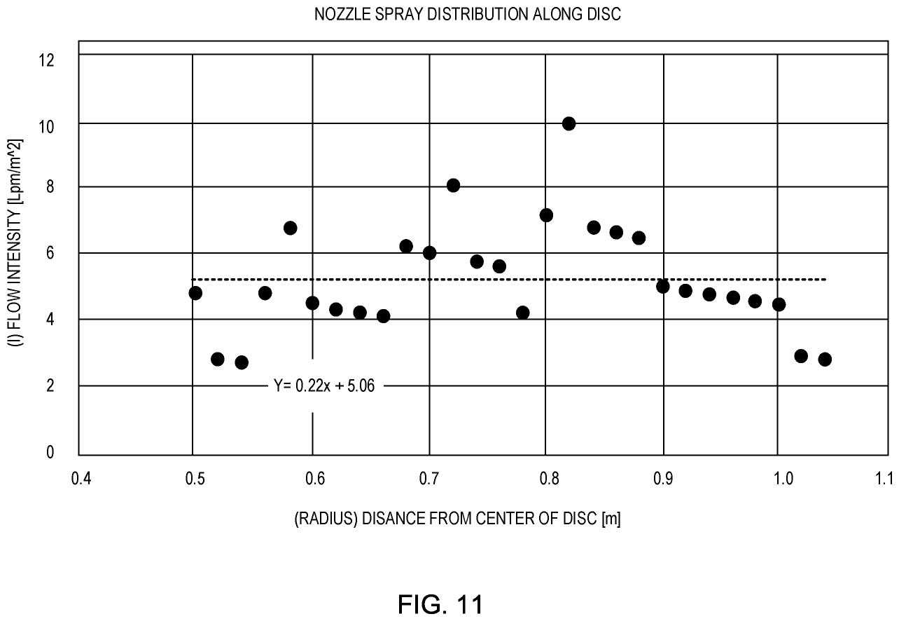

Based on the properties and arrangement of this system, a calculation of backwash intensity (“(I) Flow intensity [LPM/m²]”) as a function of distance from the rotation point of the rotating filter (“(radius) Distance from Center of Disc [m]”) was performed. From the calculations, graphical results were generated using Microsoft Excel, and the graphical results are shown in FIG. 11. The best fit line generated by Microsoft Excel for the data is represented by the equation y=0.22x+5.06, such that the slope of the line denoting backwash intensity as a function of a distance from the rotation point of the rotating filter is greater than or equal to −2 liter/min/m³, which has been found to provide improved cleaning of the filter while also reducing the energy consumption required to clean the filter (i.e., the kWh electricity consumption per cubic meter filtrate production is lower).

It is to be understood that the invention may assume various alternative variations, except where expressly specified to the contrary. It is also to be understood that the specific devices illustrated in the attached drawings, and described in the specification, are simply exemplary embodiments of the invention. Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope thereof. For example, it is to be understood that the present invention contemplates that, to the extent possible, one or more features of any embodiment can be combined with one or more features of any other embodiment. The embodiments of the invention described herein above in the context of the preferred embodiments are not to be taken as limiting the embodiments of the invention to all of the provided details thereof, since modification and variations thereof may be made without departing from the spirit and scope of the embodiments of the invention.

The invention claimed is:

1. A solid-liquid separation system, comprising:
a rotating filter configured to separate a solid-liquid containing stream into a filtrate component and a solids component, wherein the rotating filter has a rotation point around which the rotating filter rotates and a perimeter defining an end of the filter; and
a plurality of backwash orifices comprising a first backwash orifice arranged to emit backwash water at a first region of the filter and a second backwash orifice arranged to emit the backwash water at a second region of the filter different from the first region,
wherein the first region is closer to the rotation point than the second region,
wherein the second backwash orifice emits the backwash water at the second region and the first backwash orifice emits the backwash water at the first region such that the second region experiences a higher flow rate than the first region.

2. The solid-liquid separation system of claim 1, wherein the first region and the second region partially overlap such that the first backwash orifice emits the backwash water at an overlapping portion of the first and second region and/or the second backwash orifice emits the backwash water at the overlapping portion of the first and second region.

3. The solid-liquid separation system of claim 1, wherein the rotating filter comprises a first side incident with the solid-liquid containing stream and a second side from which the filtrate component emerges, wherein the plurality of backwash orifices emit the backwash water at the second side.

4. The solid-liquid separation system of claim 1, wherein the rotating filter comprises a layer of the solids component formed on a surface, wherein the first backwash orifice and the second backwash orifice are arranged to emit the backwash water at the layer of the solids component so as to remove at least a portion of the layer of the solids component from the surface.

5. The solid-liquid separation system of claim 1, wherein a slope of a line denoting backwash intensity as a function of a distance from the rotation point of the rotating filter is greater than or equal to −2 liter/min/m³.

6. The solid-liquid separation system of claim 1, wherein a slope of a line denoting backwash intensity as a function of a distance from the rotation point of the rotating filter is greater than or equal to −1 liter/min/m³.

7. The solid-liquid separation system of claim 1, wherein a slope of a line denoting backwash intensity as a function of a distance from the rotation point of the rotating filter is greater than or equal to 0 liter/min/m³.

8. The solid-liquid separation system of claim 1, wherein a slope of a line denoting backwash intensity as a function of a distance from the rotation point of the rotating filter is greater than or equal to 1 liter/min/m³.

9. The solid-liquid separation system of claim 1, wherein a slope of a line denoting backwash intensity as a function of a distance from the rotation point of the rotating filter is greater than or equal to 2 liter/min/m³.

10. The solid-liquid separation system of claim 1, wherein the rotating filter is a rotating disc and/or wherein the rotating filter is substantially vertical.

11. The solid-liquid separation system of claim 1, where the plurality of backwash orifices are directly perforated on a backwash pipe.

12. The solid-liquid separation system of claim 1, wherein the solid-liquid separation system is a wastewater treatment system in which the solid-liquid containing stream is a wastewater stream or a mixed liquor stream of secondary biological treatment systems, the solids component is a sludge component, and the filtrate component is filtered water.

13. The solid-liquid separation system of claim 1, wherein a linear velocity of the rotating filter in the first region is lower than a linear velocity of the rotating filter in the second region.

14. A solid-liquid treatment unit, comprising:
a plurality of solid-liquid separation systems of claim 1; and
a pump system in fluid communication with the plurality of solid-liquid separation systems,
wherein the pump system is configured to pump backwash water to each of the plurality of solid-liquid separation systems.

15. The solid-liquid treatment unit of claim 14, wherein a flowrate of the backwash water to a first solid-liquid separation system of the plurality of solid-liquid separation systems is within 25% deviation relative to a flowrate of the backwash water to a second solid-liquid separation system of the plurality of solid-liquid separation systems.

16. A method for cleaning a solid-liquid separation system, comprising:
arranging a plurality of backwash orifices to emit backwash water at a rotating filter configured to separate a solid-liquid containing stream into a filtrate component and a solids component, wherein the rotating filter comprises a layer of the solids component formed on a surface, wherein the rotating filter has a rotation point around which the rotating filter rotates and a perimeter defining an end of the filter; and
emitting the backwash water from the plurality of backwash orifices at the filter so as to remove at least a portion of the layer of the solids component from the surface,
wherein the plurality of backwash orifices comprise a first backwash orifice arranged to emit backwash water at a first region of the filter and a second backwash orifice arranged to emit the backwash water at a second region of the filter different from the first region,
wherein the first region is closer to the rotation point than the second region,
wherein the second backwash orifice emits the backwash water at the second region and the first backwash orifice emits the backwash water at the first region such that the second region experiences a higher flow rate than the first region.

17. The method of claim 16, wherein the first region and the second region partially overlap such that the first backwash orifice emits the backwash water at an overlapping portion of the first and second region and/or the second backwash orifice emits the backwash water at the overlapping portion of the first and second region.

18. The method of claim 16, wherein a slope of a line denoting backwash intensity as a function of a distance from the rotation point of the rotating filter is greater than or equal to −2 liter/min/m³.

19. The method of claim 16, wherein a slope of a line denoting backwash intensity as a function of a distance from the rotation point of the rotating filter is greater than or equal to −1 liter/min/m³.

20. The method of claim 16, wherein a slope of a line denoting backwash intensity as a function of a distance from the rotation point of the rotating filter is greater than or equal to 0 liter/min/m³.

21. The method of claim 16, wherein a slope of a line denoting backwash intensity as a function of a distance from the rotation point of the rotating filter is greater than or equal to 1 liter/min/m³.

22. The method of claim 16, wherein a slope of a line denoting backwash intensity as a function of a distance from the rotation point of the rotating filter is greater than or equal to 2 liter/min/m³.
